(19) United States
(12) Patent Application Publication
(10) Pub. No.: US 2026/0101222 A1
(43) Pub. Date: Apr. 9, 2026

(54) METHODS AND SYSTEMS FOR BEAM MANAGEMENT

(71) Applicant: SAMSUNG ELECTRONICS CO., LTD., Suwon-si (KR)

(72) Inventors: Yuan-sheng Cheng, San Diego, CA (US); Mohamed Awadin, San Diego, CA (US); Hamid Saber, San Diego, CA (US); Jung Hyun Bae, San Diego, CA (US); Youn-Hyoung Heo, Sunnyvale, CA (US)

(21) Appl. No.: 19/347,289

(22) Filed: Oct. 1, 2025

Related U.S. Application Data
(60) Provisional application No. 63/703,659, filed on Oct. 4, 2024.

(51) Int. Cl. H04W 24/10; H04B 7/06

(52) U.S. Cl. CPC H04W 24/10; H04B 7/0626

(57) ABSTRACT

A method for beam management may include sending, by a data collector to a data provider, a first capability report, receiving, from the data provider by the data collector, data defining a first configuration prepared based on the first capability report, the first configuration including a first set of resources and a second set of resources associated with at least one associated identifier, collecting, from the data provider by the data collector, measurements associated with the first configuration, sending, by the data collector to the data provider, a second capability report, receiving, from by the data collector, data defining a second configuration prepared based on the second capability report, generating, by the data collector, a measurement report based on the second configuration utilizing a model trained based on the measurements associated with the first configuration, and sending, by the data collector to the data provider, the measurement report.

### CROSS-REFERENCE TO RELATED APPLICATION

The present application claims priority to and the benefit under 35 U.S.C. § 119(e) of U.S. Provisional Application No. 63/703,659, filed on Oct. 4, 2024, entitled “DATA COLLECTION FOR AI/ML DL TX BEAM MANAGEMENT,” the entire disclosure of which is incorporated by reference herein.

### BACKGROUND

### 1. Field

Aspects of some embodiments relate to wireless communications.

For example, aspects of some embodiments of the present disclosure relate to methods and systems for beam management utilizing an AI/ML beam management model.

### 2. Description of the Related Art

In the 3GPP standards before Release 19 for 5G New Radio (NR), there may be no clear standard regarding an AI/ML model utilized in beam management. The beam management may include a beam prediction utilizing an AI/ML model. For example, a user equipment (UE) may perform a UE receiving (Rx) beam prediction utilizing an AI/ML model, and/or a gNB may perform a gNB transmitting (Tx) beam prediction utilizing an AI/ML model. However, for a broader selection of scenarios, such as a gNB Tx beam prediction performed by a UE, a model inference may require assistance information from other side (e.g., the network side) and the majority of Life Cycle Management (LCM) operations. For a general AI/ML framework for a wireless communication system, LCM of the AI/ML model may involve different stages, including model trainings, model deployments, model inferences, model monitoring, and model updating. Therefore, the AI/ML model may not be able to output a precise beam prediction due to the complexity of characteristics of resources. In addition, the current model development process lacks the consistency among different sets of beams during the model development process, which may increase computational workload on performing measurements of unnecessary resources and may be critical to the performance and accuracy of the beam prediction.

The above information disclosed in this Background section is only for enhancement of understanding of the background and therefore the information discussed in this Background section does not necessarily constitute prior art.

### SUMMARY

One or more aspects of the present disclosure provide a method for beam management (e.g., beam sweeping and selection, beam refinement, and/or beam tracking) that improves the efficiency and accuracy of the beam prediction output by an AI/ML model, which may be trained by data collected by a UE based on its corresponding identifier.

One or more aspects of the present disclosure also provide a data collector (e.g., a UE) for beam management (e.g., beam sweeping and selection, beam refinement, and/or beam tracking) that improves the efficiency and accuracy of the beam prediction output by an AI/ML model, which may be trained by data collected by a UE based on its corresponding identifier.

One or more aspects of the present disclosure also provide a system for beam management (e.g., beam sweeping and selection, beam refinement, and/or beam tracking) that improves the efficiency and accuracy of the beam prediction output by an AI/ML model, which may be trained by data collected by a UE based on its corresponding identifier.

Additional aspects will be set forth in part in the description which follows and, in part, will be apparent from the description, or may be learned by practice of the presented embodiments of the disclosure.

According to one or more embodiments of the present disclosure, a method may include sending, by a data collector to a data provider, a first capability report, receiving, from the data provider by the data collector, data defining a first configuration prepared based on the first capability report, where the first configuration may include a first set of resources and a second set of resources, the first set of resources and the second set of resources associated with at least one associated identifier, collecting, from the data provider by the data collector, measurements associated with the first configuration, sending, by the data collector to the data provider, a second capability report, receiving, from the data provider by the data collector, data defining a second configuration prepared based on the second capability report, generating, by the data collector, a measurement report based on the second configuration utilizing a model trained based on the measurements associated with the first configuration, and sending, by the data collector to the data provider, the measurement report.

In one or more embodiments, the first configuration may include a configuration parameter indicating the data collector to collect the measurements.

In one or more embodiments, the first set of resources may be associated with a first associated identifier, and the second set of resources may be associated with a second associated identifier.

In one or more embodiments, the second set of resources may be a subset of the first set of resources, and the first configuration may include a first associated identifier, reference signals for the first set of resources, and/or an index of reference signals for the second set of resources for determining the measurement report.

In one or more embodiments, the second set of resources may include a different set of resources from the first set of resources, and where the first configuration may include reference signals for the second set of resources that may be different from the first set of resources.

In one or more embodiments, the first configuration may include a report quantity indicating the data collector not to send information associated with measurement data on the first set of resources and the second set of resources to the data provider.

In one or more embodiments, the first configuration may include Central Processing Unit (CPU) occupation time, Channel State Information (CSI) processing time, and/or a number of occupied CPU for the data collector.

In one or more embodiments, the first capability report may include UE assistant information. The UE assistant information may include minimum measurement samples and/or maximum transmission data per session.

According to one or more embodiments of the present disclosure, a data collector may include a processing circuit configured to perform sending, to a data provider, a first capability report, receiving, from the data provider, data defining a first configuration prepared based on the first capability report, where the first configuration may include a first set of resources and a second set of resources, the first set of resources and the second set of resources associated with at least one associated identifier, collecting, from the data provider, measurements associated with the first configuration, sending, to the data provider, a second capability report, receiving, from by the data collector, data defining a second configuration prepared based on the second capability report, generating a measurement report based on the second configuration utilizing a model trained based on the measurements associated with, and sending, to the data provider, the measurement report.

In one or more embodiments, the first configuration may include a configuration parameter indicating the data collector to collect the measurements.

In one or more embodiments, the first set of resources may be associated with a first associated identifier, and the second set of resources may be associated with a second associated identifier.

In one or more embodiments, the second set of resources may be a subset of the first set of resources, and the first configuration may include a first associated identifier, reference signals for the first set of resources, and/or an index of reference signals for the second set of resources for determining the measurement report.

In one or more embodiments, the second set of resources may include a different set of resources from the first set of resources, and where the first configuration may include reference signals for the second set of resources that may be different from the first set of resources.

In one or more embodiments, the first configuration may include a report quantity indicating the data collector not to send information associated with measurement data on the first set of resources and the second set of resources to the data provider.

In one or more embodiments, the first configuration may include Central Processing Unit (CPU) occupation time, Channel State Information (CSI) processing time, and/or a number of occupied CPU for the data collector.

In one or more embodiments, the first capability report may include UE assistant information. The UE assistant information may include minimum measurement samples and/or maximum transmission data per session.

According to one or more embodiments of the present disclosure, a non-transitory computer-readable medium including instructions that, when executed by a processor, cause the processor to perform: sending, to a data provider, a first capability report, receiving, from the data provider, data defining a first configuration prepared based on the first capability report, where the first configuration may include a first set of resources and a second set of resources, the first set of resources and the second set of resources associated with at least one associated identifier, collecting, from the data provider, measurements associated with the first configuration, sending, to the data provider, a second capability report, receiving, from by the data collector, data defining a second configuration prepared based on the second capability report, generating a measurement report based on the second configuration utilizing a model trained based on the measurements associated with the first configuration, and sending, to the data provider, the measurement report.

In one or more embodiments, the first configuration may include a configuration parameter indicating the data collector to collect the measurements.

In one or more embodiments, the first set of resources may be associated with a first associated identifier, and the second set of resources may be associated with a second associated identifier.

In one or more embodiments, the second set of resources may be a subset of the first set of resources, and where the first configuration may include a first associated identifier, reference signals for the first set of resources, and/or an index of reference signals for the second set of resources for determining the measurement report.

According to one or more embodiments of the present disclosure, the method provides a method for beam management utilizing an AI/ML model trained by measurement data categorized based on its corresponding associated identifier. The method disclosed in the present disclosure may efficiently and accurately generate a measurement report (e.g., a beam prediction) based on outputs of the AI/ML model trained based on resources associated with their associated identifier. Such AI/ML model may be trained with a minimum number of associated identifiers involved (e.g., categorizing resources based on their characteristics/features to reduce the number of associated identifiers), thereby reducing the computational workload during the model development process. Furthermore, the associated identifier may be configured based on the resource level to maintain the consistency for beams during the training phase and the inference phase of the model development process, such that the outputs of the AI/ML model may be improved. Overall, the computer performance of the data collector (e.g., a UE) and the quality of transmission between the data collector and the data provider (e.g., a gNB) may be improved because unnecessary measurements on resources may be prevented or reduced by a more accurate beam prediction.

### BRIEF DESCRIPTION OF THE DRAWINGS

The above and other aspects of the present disclosure will be more clearly understood from the following detailed description of the illustrative, non-limiting embodiments with reference to the accompanying drawings.

FIG. 1 is a system diagram illustrating an example network environment, according to one or more embodiments of the present disclosure.

FIG. 2 is a diagram depicting an example method for collecting data for training an AI/ML beam management model, according to one or more embodiments of the present disclosure.

FIG. 3 is a diagram depicting an example method for model inference for AI/ML beam management based on a pretrained model, according to one or more embodiments of the present disclosure.

FIG. 4 is a diagram depicting an example method for beam management utilizing a trained AI/ML beam management model, according to one or more embodiments of the present disclosure.

FIG. 5 is a diagram depicting another example method for collecting data for training an AI/ML beam management model, according to one or more embodiments of the present disclosure.

FIG. 6 is a diagram depicting yet another example method for collecting data for training an AI/ML beam management model, according to one or more embodiments of the present disclosure.

FIG. 7 is a diagram depicting an example full beam set associated with different associated identifiers, according to one or more embodiments of the present disclosure.

FIG. 8 is a flowchart depicting an example method for beam management, according to one or more embodiments of the present disclosure.

FIG. 9 is a block diagram of an electronic device in a network environment, according to one or more embodiments of the present disclosure.

FIG. 10 shows a system including a data collector and a data provider in communication with each other, according to one or more embodiments of present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The electronic or electric devices and/or any other relevant devices or components according to embodiments of the present disclosure described herein may be implemented utilizing any suitable hardware, firmware (e.g., an application-specific integrated circuit (ASIC)), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Before release 19 of 3GPP NR standard, without a clear support from the specification, beam prediction may be performed at a UE side or a network side (e.g., a gNB) with an AI/ML-based solution. However, the full potential of AI/ML-based beam prediction may require additional information and procedure due to the nature and dynamic of beam prediction, e.g., the complexity and characteristics of the beam prediction. For example, a model development process may consider model trainings, model deployments, model inferences, model monitoring, and/or model updating, in order to develop a suitable model to provide an accurate beam prediction.

Thus, aspects of some embodiments of the present disclosure may address these various limitations of alternative techniques by introducing methods and systems for beam management utilizing an AI/ML model, where the AI/ML model may be trained based on resources associated with one or more associated identifier. For example, the resources may be grouped based on their characteristics/properties, such that the number of the associated identifiers for the resources may be reduced. Furthermore, the associated identifiers may be configured based on different association mappings of resources to maintain the consistency throughout the model development process, including the training phase and the inference phase, thereby improving the accuracy of the outputs of the AI/ML model, e.g., suitable beams for transmissions.

According to one or more embodiments of the present disclosure, the method may provide a training data set that may include resources associated with their corresponding associated identifier for training an AI/ML model. With such training set, the AI/ML model may be able to easily output a measurement report, including a beam prediction, predicted RSRP of suitable beams, predicted top K beam indices, and/or the like. The AI/ML model trained based on such training set may reduce the computational workload of a network entity (e.g., a UE or a gNB) implemented with the AI/ML model.

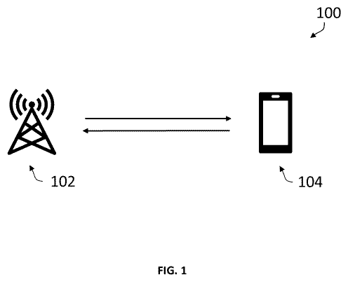

FIG. 1 is a system diagram illustrating an example network environment, in which the present methods may be applied according to one or more embodiments of the present disclosure.

Referring to FIG. 1, a wireless communication system 100 may include a base station 102 and a wireless device 104. The base station 102 may be a ground-based station (e.g., a gNB) that may receive a capability report from the wireless device 104 for beam management (e.g., beamforming, beam selection, beam switching, and/or beam tracking) and configure resources based on the capability report for the wireless device 104. The wireless device 104 may be a user equipment (UE) that may send the capability report that may indicate the sets of beams that the UE may support to the base station 102, receive configuration including resources from the base station 102, and determine a measurement report (e.g., suitable beams for transmissions) based on the configuration utilizing an AI/ML beam management model. In one or more embodiments, the AI/ML beam management model may be implemented at the base station 102 or the wireless device 104 for beam management. While only one base station 102 and only one wireless device 104 are shown in FIG. 1 for illustrative purposes, the present disclosure is not limited thereto. In practice, the wireless communication system 100 may include a number of base stations and a number of wireless devices, and the base stations and the wireless devices may be operationally coupled with each other and/or with a vast network of base stations, wireless devices, and/or other network systems and devices.

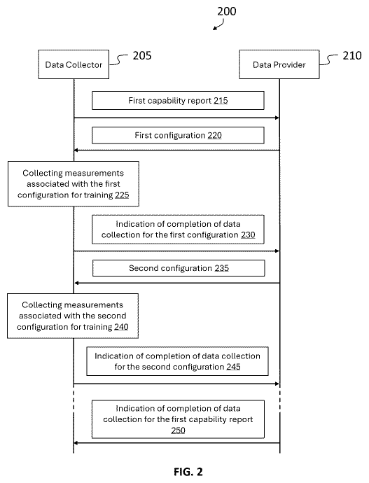

Both of the base station 102 and the wireless device 104 may implement the AI/ML beam management model to determine suitable, efficient beams for transmissions, such that the transmission between the base station 102 and the wireless device 104 may be transmitted with the determined beams to concentrate signal energy towards each other, thereby increasing signal quality and data rates, while also reducing interference. Further details of systems and methods for beam management may be described in more detail with reference to FIG. 2.

FIG. 2 is a diagram depicting aspects of a method for collecting data for training an AI/ML beam management model, according to one or more embodiments of the present disclosure. Although FIG. 2 illustrates various operations in a method for collecting data for training an AI/ML beam management model, the present disclosure is not limited thereto, and according to various embodiments, the method may include additional operations, or fewer operations, or the order of operations may vary, unless otherwise stated or implied, without departing from the spirit and scope of embodiments according to the present disclosure.

Referring to FIG. 2, a method 200 for collecting data for training an AI/ML beam management model may be performed by a data collector 205 that may be connected with a data provider 210. The method 200 may be a data collection phase of the model development process. In one or more embodiments, the data collector 205 may be a UE or a gNB. For example, if (e.g., when) the data collector 205 is a UE, the data provider 210 may be a gNB and/or any network node at the network side for providing measurement data by sweeping through transmit beams. The gNB may be a dedicated gNB specific for the UE to collect AI/ML beam management-based data, a regular gNB in the network, and/or a virtual gNB which may be a test equipment. Likewise, if (e.g., when) the data collector 205 is a gNB, the data provider 210 may be a UE that may report measurements (e.g., the Layer 1 Reference Signal Received Power (L1-RSRP) measurements) of the beams that the gNB sweeps to the gNB.

In the method 200, the data collector 205 may start with sending a first capability report 215 to the data provider 210 for the data provider 210 to configure suitable beams for transmissions. For example, the capability report may indicate the capability of the data collector 205 for supporting beams associated with Set A beams and Set B beams. After the data collector 205 (e.g., a UE) is in the connection mode, the data collector 205 may send the first capability report 215, which may include the capability for supporting certain combinations of Set A beams and Set B beams, and receive a first configuration 220 prepared based on the first capability report 215 from the data provider 210. The capability may be transmitted in either the first capability report 215 or an Radio Resource Control (RRC) signaling, e.g. UE assistance information, such that the data provider 210 (e.g., a gNB) may know how to provide required configurations for the data collector 205. For example, the configurations (e.g., the first configuration 220) prepared by the data provider 210 may be associated with the combinations of Set A beams and Set B beams that the data collector 205 may support and are indicated in the first capability report 215. The first configuration 220 may be utilized to initiate the data collector 205 to collect data based on measuring the configured resources.

In one or more embodiments, for training the AI/ML beam management model, especially for supervised learning, the performance of the AI/ML beam management model may be relatively improved (e.g., compared to alternative systems) if (e.g., when) the size of the collected data is larger. If (e.g., when) the available collected data for training the AI/ML beam management model may reach a certain number, diminishing return in term of performance may be expected. In the case of AI/ML beam management, a minimum amount of collected data for training the AI/ML beam management model may be required to achieve a set accuracy of beam prediction.

The size of the collected data for training the AI/ML beam management model may depend on the implementation of the data collector 205 (e.g., model type, size, other neural network (NN) parameters, and/or the like) and performance requirements. Furthermore, the data collector 205 may have other limitation, e.g., the data collector 205 may have limited storage for temporarily storing the collected data in a single data collection session and be suitable to break one data collection into multiple sessions. For the AI/ML beam management model implemented at the data collector 205, the data provider 210 at the network side (e.g., a gNB in the network) may not know either the required minimum data or the maximum data that the data collector UE may need and support, respectively, in a data collection session. The training of the AI/ML beam management model may be handled by an offline inter vendor collaboration or a similar on-demand signaling during the data collection procedure.

In one or more embodiments, for communicating the requirements of the data collector 205 between the data collector 205 and the data provider 210, the data collector 205 may signal “minimum required samples” and “maximum data per session” to the data provider 210 by either via a new capability report for the data collection session or by a UE assistant information signaling. The minimum required samples and maximum data per session may be represented as the minimum total required training time and maximum total required training time, although there is a variance depending on the periodicity of resource for collected data for training. If (e.g., when) the data collector 205 is informed the periodicity of resource, required training time may be calculated based on the resource periodicity. Otherwise, the reference periodicity may be inferred. The data collector 205 may also inform the resources periodically or event-triggered based on the remaining required samples or required time which may be utilized for the data provider 210 to decide when the corresponding resources may be released.

Because the minimum data (e.g., the required minimum data) may depend on the complexity/structure of models, the amount or the size of the required minimum data may be various. In one or more embodiments, the data collector 205 may indicate a particular size of the pair of Set A beams and Set B beams that the data collector 205 may support in the first capability report 215, or the data collector 205 may indicate the maximum supported sizes of Set A beams and Set B beams in the first capability report 215.

The data collector 205 may receive a first configuration 220 prepared based on the first capability report 215 from the data provider 210, and collect measurements associated with the first configuration for training the AI/ML beam management model 225. For example, based on the received first capability report 215, the data provider 210 may send the first configuration 220 to the data collector 215. The first configuration 220 may include resources for Set A beams and Set B beams and their associated identifier(s). The associated identifier may provide additional condition/information regarding the network side (e.g., additional condition related to the data provider 220, such as a network-specific beam codebook design). The first configuration 220 may also trigger the data collector 205 to collect data (e.g., data for training the AI/ML beam management model). Due to the nature of required data collection for training the AI/ML beam management model, the resources may be periodic reference signals, semipersistent Channel State Information-Reference Signal (CSI-RS), and/or Synchronization Signal Block (SSB). The data collection procedure may be a CSI-report, in which the reporting quantity may be set to “none” to indicate the data collector 205 to collect data for training the AI/ML beam management model and not to send CSI to the data provider 210. In one or more embodiments, the first configuration 220 may indicate how long the data collector 205 may need to measure (e.g., the total time to collect the data for training the AI/ML beam management model). Furthermore, the data collector 205 may send an indication of completion of data collection for the first configuration 230. For example, the data collector 205 (e.g., a UE) may be desired to inform the data provider 210 (e.g., a gNB) that the data collection for the first configuration 220 is completed after enough data is collected.

In terms of the consistency of Set A beams and Set B beams across the training phase and the inference phase of the model development process, the definition of the consistency may include both physical consistency and ordering consistency between Set A beams and Set B beams. The physical consistency of Set A beams and Set B beams may refer to the beam shapes and/or angles (or beam codebook). For example, a tilt angle of the data provider 210 (e.g., a gNB) and other transmitter hardware properties of the data provider 210 to transmit the beams may desirably be consistent throughout the model development process or at least within a set range (e.g., certain tolerated requirements or a tolerable fluctuation). Additionally, the physical consistency may include the consistency with respect to certain properties, such as Doppler shift, Doppler spread, average delay, delay spread, spatial receiver parameter, and/or the like. Thy physical consistency may include similar Quasi Co Location (QCL) type, such as QCL-Type A, QCL-Type B, QCL-Type C, QCL-Type D, and/or the like. The ordering consistency of Set A beams and Set B beams may require the beam ordering among Set A beams and Set B beams and the association between Set A beams and Set B beams to be consistent during the training phase and the inference phase of the model development process.

For example, both of Set A beams and Set B beams may be associated with a CSI resource set, and the CSI resource set may be configured by NZP-CSI-RS-ResourceSet IE or other Information Elements (IEs) with a similar structure. In this case (e.g., Set A beams and Set B beams configured by the CSI framework), it may indicate that the data provider 210 (e.g., a gNB) may utilize the CSI resource set inside Set A beams and Set B beams to transmit the associated beams in Set A beams or Set B beams.

Furthermore, the consistency of an associated identifier during the training phase and the inference phase of the model development process may depend on a level of resources that the associated identifier is bundled with. For example, the data collector 205 (e.g., a UE) may assume that the similar properties of a DL Tx beam or beam set/list may be associated with the same associated identifier.

There are four scenarios related to the associated identifier and the CSI resource set:

Scenario 1: One associated identifier may be linked to an individual CSI resource. Scenario 1 may have the physical consistency of Set A beams and Set B beams.

Scenario 2: One associated identifier may be linked to an individual CSI resource set, where Set A beams and Set B beams may have different associated identifiers. Scenario 2 may have the physical consistency and the ordering consistency (e.g., an index ordering consistency).

Scenario 3: One associated identifier may be linked to both CSI resource sets, where Set A beams and Set B beams may be associated with an associated identifier (e.g., the same associated identifier). Scenario 3 may have the physical consistency and the ordering consistency (e.g., an index ordering consistency). In this case, the associated identifier may reflect the input and output of the AI/ML beam management model. For example, the single associated identifier may reflect the consistency of Set B beams across the training phase and the inference phase and reflect the consistency of Set A beams across the training phase and the inference phase, where Set A beams and Set B beams may construct one pair of beams. In one or more embodiments, the properties of Set A beams and Set B beams, such as the used beam codebook, may be different. For example, Set B beams may include wide beams while Set A beams may include narrow beams, Set A beams and Set B beams may be linked to the same associated identifier since the pair of Set A beams and Set B beams may be utilized as an input and an output of the AI/ML beam management model.

Scenario 4: One associated identifier may be linked to a full beam set. The full beam set may be a mother beam codebook of Set A beams and Set B beams. Scenario 4 may have the physical consistency for the full beam set. In one or more embodiments, an additional signaling for indicating Set A beams and Set B beams may be required at least during the inference phase for the ordering consistency.

In one or more embodiments, the consistency provided by the associated identifier may be desired to at least be consistent within a cell, such that the data collector 205 (e.g., a UE) may be able to identify different network associate conditions within the cell through the associated identifier and some properties of the cell (e.g., specific properties of the cell for identification), such as a global cell identifier. For example, if (e.g., when) the data collector 205 may assume that the additional conditions at the network side with the same associated identifier are consistent among multiple cells, it may be helpful to reduce the computational load (e.g., lower the computational complexity) at the data collector 205, e.g., reducing the computational load on the data collection, the training of the AI/ML beam management model, the model management.

Since Scenario 1 and Scenario 2 may involve more associated identifiers in total, which may complicate the model development process, Scenario 3 (e.g., an associated identifier linked to a particular pair of Set A beams and Set B beams) and Scenario 4 (e.g., an associated identifier linked to a full beam set of Set A beams and Set B beams) may be applied in the method 200 for collecting data for training an AI/ML beam management model.

Referring to FIG. 2, the first configuration 220 may include resources for Set A beams and Set B beams that are associated with an associated identifier (e.g., the same associated identifier).

In one or more embodiments, the data collector 205 that may be configured with the first configuration 220 and/or the second configuration 235 (e.g., a CSI report configuration) may measure the downlink channel, compute the CSI, and report the downlink channel as Uplink Control Information (UCI) to the data provider 210. If (e.g., when) the data collector 205 is to only collect data that the data collector 205 may not need to report the CSI to the data provider 210. Reporting the CSI to the data provider 210 may add a burden to the data collector 205 as the UCI transmission may require uplink processing including channel coding, waveform generation, and/or other steps of an uplink channel transmission. Therefore, the data provider 210 may configure the data collector 205 via RRC with a CSI report configuration to indicate the data collector 205 for the data collection with no CSI report. For example, an explicit Information Element (IE) in the CSI report configuration may indicate that this report is for the data collection, or an IE may be implied implicitly by setting the report quantity to “None”.

In one or more embodiments, the data collector 205 may request the data provider 210 to start a data collection session. The request may be delivered via a scheduling request (SR) dedicated to the data collection. For example, after a certain time duration from the end of the PUCCH carrying the SR channel, the data collector 205 may assume that the CSI report configuration for data collection is active. Therefore, the data collector 205 may know the resources to measure the channel, e.g., L1-RSRP. The set of RSs configured in the CSI report configuration may be transmitted for a specific time window for the data collector 205 to construct the training data set, select pairs of Set A and Set B, and train models for the selected pairs of Set A and Set B.

The activation of the CSI report configuration for data collection may be carried out in suitable ways. For example, Downlink Control Information (DCI) may trigger the CSI report configuration. In one or more embodiments, the activation command may be delivered via MAC Control Element (MAC-CE). Table 1 below indicate an example of a CSI report configuration for data collection.

TABLE 1

| CSI-ReportConfig ::= | SEQUENCE { | |
|---|---|---|
| reportConfigId | CSI-ReportConfigId, | |
| carrier | ServCellIndex | OPTIONAL, |
| | | -- Need S |

| | |
|---|---|
| resourcesForChannelMeasurement | CSI-ResourceConfigId, |

```
  reportquantity =”None” or “data collection”
  .
  .
  .
}
```

Referring to Table 1, the data collector 205 may be configured with a CSI-ReportConfig with the higher layer parameter reportquantity (e.g., reportQuantity-r19) set to “None” or “data collection” to only collect data and not to report information associated with measurement data on the selected pairs of Set A and Set B (e.g., the CSI) to the data provider 210.

In one or more embodiments, for the data collector 205 configured with a CSI-ReportConfig with the higher layer parameter reportQuantity-r19 set to “none-bm-r19”, the data collector 205 may be configured with one or two associated identifier(s) in CSI-ReportConfig. If (e.g., when) the associated identifier(s) (e.g., associatedIDforSetA-r19 and associatedIDforSetB-r19) are configured, the associated identifier(s) may be associated with the resource set of the second Resource Setting and of the first Resource Setting, respectively.

In one or more embodiments, for the data collector 205 configured with a CSI-ReportConfig with the higher layer parameter reportQuantity-r19 set to “none-bm-r19”, if (e.g., when) the same associated identifier is configured to be associated with different resource sets, the data collector 205 may assume similar properties for the CSI-RS resources and/or SS/PBCH block resources among those different resource sets, irrespective of if (e.g., when) the corresponding Resource Setting(s) is configured by higher layer signaling or released.

In one or more embodiments, if (e.g., when) the data collector 205 is configured with a CSI-ReportConfig with the higher layer parameter reportQuantity set to “none”, or “none-bm-r19”, the data collector 205 may not report any quantity for the CSI-ReportConfig.

In one or more embodiments, the CSI report configuration for data collection may occupy CPU for a duration of time, e.g., an occupation window. For a CSI report configuration for which the data collector 205 may report the CSI to the data provider 210, the occupation window may end at the end of the ending symbol of the uplink channel conveying the CSI report. If (e.g., when) there is no CSI report to the data provider 210, the occupation window may end at certain time after the occupation window starts. For example, the occupation window may start from the first symbol of the RS in each transmission occasion and end after the symbol of Z₃′ after the last symbol of the latest RS in the transmission occasion. The transmission occasion may be defined from the first symbol of the earliest RS in the CSI-RS set to the ending symbol of the latest CSI-RS in the set within a period for SP/P CSI report. The transmission occasion may also be defined from the first symbol of the earliest CSI-RS to the ending symbol of the latest CSI-RS in the triggered Aperiodic (AP)-CSI RS set by the DCI. In one or more embodiments, similar behavior to the legacy beam management may be adopted for data collection for training the AIML beam management model (e.g., for beam predictions in spatial domain and time domain) based on the symbols of Z₃ and Z₃′. Values of Z₃ and Z₃′ may be defined for the beam predictions in spatial domain and time domain because of the implementation of the data collector 205 may be different. In particular, the values of Z₃ and Z₃′ may be relaxed by certain offsets.

For the CSI processing time and a number of occupied CPUs, similar behavior to the legacy P3 beam management may be taken as the behavior of the data collector 205.

In one or more embodiments, for the CPU occupation time for CSI-ReportConfig with the higher layer parameter reportQuantity-r19 set to “none” or “none-bm-r19”, processing of a CSI report may occupy a number of CPUs for a number of symbols. For example, the number of CPUs may be 1 (e.g., Ocpu=1) for a CSI report with CSI-ReportConfig with higher layer parameter reportQuantity set to “none”, “none-csi-r19”, or “none-bm-r19”.

In one or more embodiments, for a CSI report with CSI-ReportConfig with higher layer parameter reportQuantity set to “none”, CSI-RS-ResourceSet with higher layer parameter trs-Info not configured, or reportQuantity set to “none-bm-r19” or “none-csi-r19”, the CPU(s) may be occupied for a number of Orthogonal frequency-division multiplexing (OFDM) symbols. For example, a semi-persistent CSI report (e.g., excluding an initial semi-persistent CSI report on PUSCH after the PDCCH triggering the report) may occupy CPU(s) from the first symbol of the earliest one of each transmission occasion of periodic or semi-persistent CSI-RS/SSB resource for channel measurement for L1-RSRP computation, until Z₃′ symbols after the last symbol of the latest one of the CSI-RS/SSB resource for channel measurement for L1-RSRP computation in each transmission occasion. Likewise, an aperiodic CSI report occupies CPU(s) from the first symbol after the PDCCH triggering the CSI report until the last symbol between Z₃ symbols after the first symbol after the PDCCH triggering the CSI report and Z₃′ symbols after the last symbol of the latest one of each CSI-RS/SSB resource for channel measurement for L1-RSRP computation.

After the data collection associated with the first configuration 220 is completed, the data provider 210 may send a second configuration 235 based on the first capability report 215 to the data collector 205, and the data collector 205 may collect measurements based on the second configuration for training the AI/ML beam management model 240, which may be similar to or substantially the same as the data collection based on the first configuration for training the AI/ML beam management model 225. In one or more embodiments, the data provider 210 may provide yet another configuration based on the first capability report 215, and in response to yet another configuration, the data collector 205 may repeat a data collection process that is similar to or substantially the same as the data collection based on the first configuration for training the AI/ML beam management model 225 and the data collection based on the second configuration for training the AI/ML beam management model 240.

After the data collection 240 is completed, the data collector 205 may send an indication of completion of data collection for the second configuration 245 to the data provider 210. For example, after the data collection procedure (e.g., the data collections 225 and 240) associated with all combinations of Set A beams, Set B beams, and their associated identifier) which may be accessible by the data provider 210 is completed, the data provider 210 may indicate the data collector 205 that the whole data collection is completed. The data collector 205 may assume that all the required data for training the AI/ML beam management model and send the data to an offline server for training the AI/ML beam management model.

In one or more embodiments, during the data collection 240, the data collector 205 may send an indication (e.g., a stop indication) for all CSI report configuration identifier and/or a specific CSI report configuration identifier. For example, the data collector 205 may send a stop indication based on an CSI report configuration identifier to the data provider 210 to indicate the data provider 210 to stop sending measurements associated with the first configuration 220.

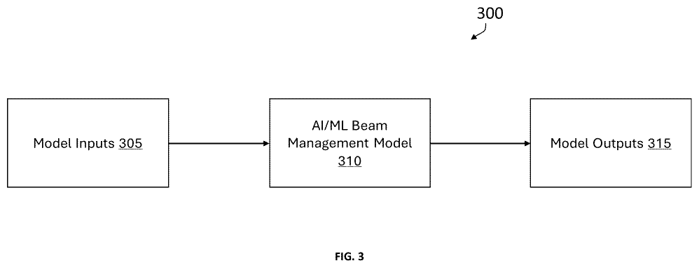

FIG. 3 is a diagram depicting aspects of a process for model inference based on a pretrained AI/ML beam management model, according to one or more embodiments of the present disclosure.

Referring to FIG. 3, a model inference 300 based on a pretrained AI/ML beam management model may include feeding model inputs 305 into an AI/ML beam management 310 and generating model outputs 310. The model inputs 305 may be measurements associated with resources (e.g., Reference Signal Received Power (RSRP) of reference signals) collected by a data collector (e.g., a UE; the data collector 205 shown in FIG. 2) from a data provider (e.g., a gNB; the data provider 210 shown in FIG. 2). For example, the model inputs 305 may be the data collected during the data collection process in FIG. 2. The model inputs 305 may include periodic reference signals corresponding to one or more associated identifiers. The AI/ML beam management 310 may then generate the model outputs 315 based on the model inputs 305. The model outputs 315 may include predicted RSRP of suitable beams, predicted top K beam indices, and/or the like. The data collector may generate a measurement report based on the model outputs 315 and send the measurement report to the data provider for further transmissions and Life Cycle Management (LCM) for the AI/ML beam management model 310 and/or any other AI/ML models.

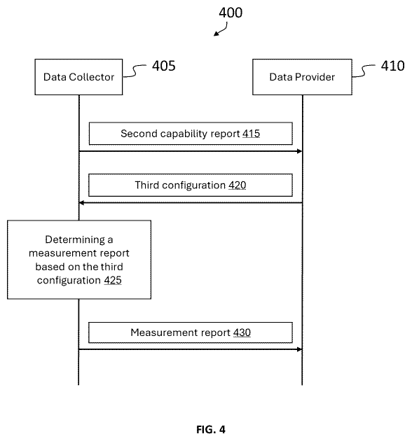

During the training process 300, if (e.g., when) an associated identifier is cell-specific, the data provider (e.g., a gNB) may only represent an associated identifier that the data provider may support and the applicable pair combinations of Set A beams and Set B beams. For example, if (e.g., when) the data collector (e.g., a UE) supports a size of Set A beams and Set B beams, e.g., (64,16) and/or (32,8), the data provider may look through all available beam codebook combinations supported in this cell, and conduct the data collection with all the pair combinations of Set A beams and Set B beams that are associated with this cell-specific associated identifier and have a pair size in (64, 16) or (32,8). Therefore, during the inference phase, which may be described in more detail with reference to FIG. 4, after the data collector is connected with the data provider, by the identification of a cell (e.g., via a cell identifier), if (e.g., when) the data collector learns that the data provider is within one of the cells that the data collector has collected data from and/or trained models based on the collected data, the data collector may report that the data collector may support the pair size of (64,16) and (32,8) with or without the corresponding associated identifier(s) (e.g., a cell-specific identifier) to the data provider, such that the data provider may know/identify all the available supporting models that the data collector currently may have.

Furthermore, in this case (e.g., the associated identifier is cell-specific), the data collector may only report the associated identifiers that the data collector supports in its capability signaling (e.g., the capability report or additional signaling), such that the data provider may identify the properties of Set A beams and Set B beams corresponding to the indicated associated identifiers. If (e.g., when) the associated identifier is linked with multiple pairs of Set A beams and Set B beams, as shown in Table 2, the data collector may be desired to additionally indicate the index of the supported Set B beams, e.g., B11, B12, B13, and/or the like. For example, the data collector may report the configured associated identifier of the supported Set B beams during the training phase. If (e.g., when) the data collector indicates only the associated identifier (e.g., does not provide the associated identifier of the supported Set B beams), the data collector may support all pairs of Set A beams and Set B beams linked to the associated identifier.

TABLE 2

| Associated identifier (ID) | Pairs of Set A and Set B |
|---|---|
| Associated ID #1 | (Set A1, Set B11) |
| | (Set A1, Set B12) |
| | (Set A1, Set B13) |
| | Where Set A is the same across |
| | different pairs, but Set B varies from one |
| | pair to another |
| Associated ID #2 | (Set A2, Set B21) |
| | (Set A2, Set B22) |
| | (Set A2, Set B23) |
| | (Set A2, Set B24) |
| | This associated identifier linked with |
| | multiple pairs of Set A and Set B that |
| | are selected from among codebooks for |
| | narrow beams and wide beams |
| Associated ID #3 | (Set A3, Set B31) |
| | (Set A3, Set B32) |

Table 2 shows an example of a network supporting multiple associated identifiers. As depicted in Table 2, Associated ID #1 may be linked with multiple pairs, e.g., (Set A1, Set B11), (Set A1, Set B12), and (Set A1, Set B13). Among these pairs, Set A1 is common but paired with different Sets B, such as Set B11, Set B12, and Set B13. In this example, the beam pairs of (Set A1, Set B11), (Set A1, Set B12), and (Set A1, Set B13) may have the same beam properties, such as the same codebook may be utilized to generate all of these pairs. For example, all of pairs may include narrow beams from the same codebook. However, the size of Set B11, Set B12 and B13 may be different.

As depicted in Table 2, for Associated ID #2, a different codebook may be utilized to generate the pairs of Set A beams and Set B beams. For example, Set A2 may be generated from a codebook for narrow beams, and Set B21, Set B22, Set B23, and Set B24 may be generated from the same codebook for wide beams, e.g., Set B21={SSB1, SSB2}, while Set B22={SSB 3, SSB 4, SSB 5, SSB 6}, where all the SSBs (e.g., SSB1, SSB2, SSB3, SSB 4, SSB 5, and SSB 6) may be generated from the same codebook. This approach may be beneficial by reducing the number of needed associated identifiers by linking a corresponding associated identifier to the codebook(s) utilized for generating Set A beams and Set B beams, thereby reducing computational complexity and bandwidth and improving computational performance in training the AI/ML beam management model.

Referring back to FIG. 2, in the case that Set B may be a subset of Set A, transmitting RSs may be enough for constructing Set A, and there is no need to transmit Set B again. Nevertheless, the composite of Set B may be indicated to the data collector 205.

The data collector 205 may utilize the first capability report 215 to indicate the supported properties of Set A and Set B that may be supported by the data collector 205. The CSI framework discussed in FIG. 2 may be utilized. In this case (Set B is a subset of Set A), the configurations may include the associated identifier, the RSs for Set A, the indices of RSs to be utilized as Set B in the inference phase, and/or an additional identifier reflecting such Set B. In one or more embodiments, the parameter in the configurations may include CSI-ReportConfig, CSI-ResoruceConfig, NZP-CSI-RS-ResourceSet, CSI-SSB-ResourceSet, and/or the like. For example, the configuration may include at least one of the following: (1) an associated identifier, (2) RSs for Set A, such as a set of NZP-CSI-RS-Resources, and (3) a selection of a subset of RSs which will be utilized as Set B during the inference phase.

If (e.g., when) multiple Sets B are provided, e.g., Set B11, Set B12, Set B13, and/or the like, an associated identifier may be assigned explicitly for each subset. Another approach is to implicitly assign an associated identifier for each Set B based on some specific/unique properties of each Set B. For example, if (e.g., when) Sets B linked to the same associated identifier may have different sizes, then some rules may be applied. For example, a Set B with the smallest size may be assigned with Associated ID #0, a Set B with the second smallest size may be assigned with Associated ID #1, and so on.

Such configurations may be provided for multiple data collectors. Therefore, such configurations may be broadcasted or multi-casted to a group of data collectors. For example, the configurations may be included in Remaining Minimum System Information (RMSI) and Other System Information (OSI).

In one or more embodiments, the configuration/reporting may be set to “none” or an indication that data collection is completed (e.g., data collection). In this case, the report quantity in the configuration may be set to “data collection” to indicate the data collector to collect data. If (e.g., when) the configuration/report may take two values, e.g., 0 or 1, to indicate whether the data collection is completed or not. This single bit may be treated as legacy CSI reporting that may be carried on PUSCH or PUCCH. Additionally, the configuration/reporting may be periodic, semi-persistent, or dynamic. The data collection status may include more information, such as the associated identifier whose data collection is or is not completed. The configuration/reporting for the data collection status may be linked to a particular associated identifier, e.g., a gNB may inquire about the data collection status for a particular associated identifier, or the configuration/reporting may be linked to all configured Associated identifiers.

To provide a further flexibility to the data collector, the data collector may transmit a request for the data collection, in addition to the capability report. Such request may be carried on PUCCH, such as dedicated Scheduling Request (SR), and/or PRACH by allocated some RACH resources to be served as the request.

In one or more embodiments, the data collector may only report supporting certain combinations of Set A beams and Set B beams (e.g., by the size of combination of sets), if (e.g., when) the data collector has all the associated identifier(s) collected from the same data provider and trained models based on the associated identifier(s) from same data provider. Otherwise, if (e.g., when) only data with a portion of associated identifier(s) is associated with a certain size of pair (e.g., the data is not from the cell that the data provider is previously within or is not collected from the same provider), the data collector may not confirm whether it supports such pair. Therefore, this approach (e.g., all the associated identifier(s) corresponding to the same data provider) may reduce the overhead on reporting and improve the computational performance.

If (e.g., when) an associated identifier is consistent across multiple cells (e.g., a group of cells), such associated identifier may be a specific identifier throughout the cells, e.g., such associated identifier may be Public Land Mobile Network (PLMN) if (e.g., when) the consistency is across all cells within a carrier.

In one or more embodiments, such group of cells may be network-specific, such that within each group of cells, the associated identifier among each group of cells is consistent. The network that supports AI/ML beam management functionalities may define such network-specific groups of cells with a specific/unique group identifier. For the data collector planning to support AI/ML beam management functionalities in this network (e.g., the network that supports AI/ML beam management functionalities), the data collector may be desired to collect data across different groups of cells. During the training phase, the data collector may identify the associated identifier of group of cells where it collects data. During the inference phase, after the data collector connects to the data provider, the data collector may acquire this specific/unique, network-specific group identifier before reporting applicable combinations of Set A beams and Set B beams to the data provider.

Therefore, in a global associated identifier (e.g., an associated identifier linked to multiple cells), before starting the inference phase, the data collector may be desired to identify to which group of cells that the data collector is connected to. Then, during the inference phase, the capability report (e.g., the first capability report 215 and the second capability report 235 shown in FIG. 2) may include associated identifiers that the data collector supports and/or the properties of Set A beams and Set B beams that was collected from the same group of cells during the data collection process (e.g., the data collection 225 and the data collection 240 shown in FIG. 2). In this case, the data collector may only report the associated identifiers that it supports in its capability signaling (e.g., the first capability report 215 and the second capability report 235 shown in FIG. 2). For example, the data provider may identify the properties of Set A beams and Set B beams corresponding to the indicated associated identifiers.

FIG. 4 is a diagram depicting aspects of a method for beam management utilizing a trained AI/ML beam management model, according to one or more embodiments of the present disclosure. Although FIG. 4 illustrates various operations in a method for beam management utilizing a trained AI/ML beam management model, the present disclosure is not limited thereto, and according to various embodiments, the method may include additional operations, or fewer operations, or the order of operations may vary, unless otherwise stated or implied, without departing from the spirit and scope of embodiments according to the present disclosure.

Referring to FIG. 4, a method 400 for collecting data for beam management utilizing a trained AI/ML beam management model may be performed by a data collector 405 that may be connected with a data provider 410. The method 400 may be an inference phase of the model development process. In one or more embodiments, the data collector 405 may be a UE or a gNB. For example, if (e.g., when) the data collector 405 is a UE, the data provider 410 may be a gNB and/or any network node at the network side for providing measurement data by sweeping through transmit beams. The gNB may be a dedicated gNB specific for the UE to collect AI/ML beam management-based data, a regular gNB in the network, and/or a virtual gNB which may be a test equipment. Likewise, if (e.g., when) the data collector 405 is a gNB, the data provider 410 may be a UE that may report measurements (e.g., the Layer 1 Reference Signal Received Power (L1-RSRP) measurements) of the beams that the gNB sweeps to the gNB.

In the method 400, the data collector 405 may start with sending a second capability report 415 to the data provider 410 for the data provider 410 to configure suitable beams for transmissions. For example, the capability report may indicate the capability of the data collector 405 for supporting beams associated with Set A beams and Set B beams. After the data collector 405 (e.g., a UE) is in the connection mode, the data collector 405 may send the second capability report 415, which may include the capability for supporting certain combinations of Set A beams and Set B beams, and receive a third configuration 420 prepared based on the second capability report 415 from the data provider 410. The capability may be transmitted in either the second capability report 415 or an RRC signaling, e.g. UE assistance information, such that the data provider 410 (e.g., a gNB) may know how to provide required configurations for the data collector 405. For example, the configurations (e.g., the third configuration 420) prepared by the data provider 410 may be associated with the combinations of Set A beams and Set B beams that the data collector 405 may support and are indicated in the second capability report 415.

Upon receiving the third configuration 420, the data collector 405 may determine a measurement report based on the third configuration utilizing the trained AI/ML beam management model 425. For example, the data collector 405 may generate a measurement report based on outputs of the trained AI/ML beam management model utilizing the third configuration 420 as an input (e.g., a model that is trained based on the methods disclosed in FIGS. 2 and 3). The data collector 405 may send the measurement report 430 to the data provider 410 for future transmissions and optimizing the trained AI/ML beam management model. The measurement report 420 may include suitable beams, predicted RSRP of suitable beams, predicted top K beam indices, and/or the like.

During an inference phase of the model development process, the data collector 405 (e.g., a commercialized UE) may first connect to the data provider 410. The data provider 410 may be a gNB in an active network. The data collector may have some trained models (including the AI/ML beam management model 310 shown in FIG. 3) based on an offline training on the data collected during the data collection phase (e.g., the data collection process shown in FIG. 2). The data collector 405 may send the second capability report 415 to the data provider 410 to inform its capability to run AI/ML BM predictions. Similar to the first capability report 215 shown in FIG. 2, the second capability 415 may indicate all the supporting AI/ML beam management predictions for the data collector 405. In addition, the second capability report 415 may include information that the data collector 405 already collects and trains the AI/ML beam management model accessible to the data provider 410. The date provider 410 may then configure resources and report the configured resources and/or the measurement report 430 for an inference report, and/or may perform LCM for supporting models (e.g., the models implemented at the data collector 405) indicated by the second capability report 415.

In one or more embodiments, the data collector 405 may consider Set A beams and Set B beams the same during the training phase (e.g., the method discussed in FIG. 3) and the inference phase. One approach to considering/treating Set A beams and Set B beams the same may be based on an existing CSI-framework, such that Set A beams and Set B beams may be configured with associated CSI-RS resources/a set configuration (e.g., a configuration including SSB as part of NZP-CSI resources). The CSI-RS resource(s) and associated report configurations may include time-frequency parameters, QCL-relationship, report type, and/or the like. The parameters for CSI-RS resources associated with Set A beams and Set B beams may be different during the training phase. From the perspective of the data provider 410, it may be beneficial to the flexibility on scheduling and resource allocation by not utilizing the same CSI-RS configurations. From the perspective of the data collector, it may be also beneficial to identify Set A beams and Set B beams without the need to have the same configuration for Set A beams and Set B beams.

The following parameters or their combination(s) may be utilized to identify Set A beams and Set B beams during the training phase and the inference phase: (1) size of Set A beams and Set B beams, (2) type of RS (e.g., NZP-CSI or SSB, including the time property of RS), (3) frequency range or frequency band of RS associated with Set A beams and Set B beams, and (4) type of CSI report associated with configurations of Set A beams and Set B beams. For example, if (e.g., when) Set A beams and Set B beams are identified solely based on the size of the two sets (e.g., Set A and Set B), CSI resource sets corresponding to Set A and Set B with the same elements in the resource sets may be treated as identical during the training phase and the inference phase.

In one or more embodiments, given that each single associated ID may be linked to only a single Set A, during the inference phase, Set A may not be configured. In this case, the data provider 410 may only configure Set B and indicate the associated identifier in addition to an associated identifier of Set B (e.g., if there are multiple Sets B linked to the same associated identifier). If (e.g., when) different Sets B having some properties in common that may be implicitly determined by the data collector 405, e.g., the size of Set B, then the data provider 410 may not need to explicitly indicate the associated identifier of Set B.

Additionally, if (e.g., when) Set B includes a wide beam including SSBs, during the inference phase, the data provider 410 may not need to configure Set B. In this case, the data provider 410 may solely indicate the associated identifier without configuring either Set A or Set B. The data collector 405 may utilize Set A configured during the training phase and measure the same SSB indices to obtain Set B utilized during the training phase.

Referring back to FIG. 2, in Scenario 4 (e.g., an associated identifier associated with a full union of Set A and Set B), once the data collection process (e.g., the data collection discussed in FIG. 2) is started/activated, the data collector may collect data by performing measurements of RSs configured for the data collection. The data provider may configure N RSs with N different identifiers for the data collection as a set in the data collection (e.g., a CSI report configuration). The data collector may measure the RSs in the data collection process and create a training data set to train the AI/ML beam management model and/or other models. From the measured set of RSs, the data collector may group the RSs in to Set A or Set B based on the implementation of the data collector and train a model. It is UE implementation on how to group the RSs into two different sets B and A and train a model for generating pairs of Set A and Set B (e.g., pair (B, A)). For example, with a set size of pair |B| and |A|, the data collector may create two pairs as follows:

$${B}_{1} = ( {i}_{1} , … , {i}_{\vert B \vert} ) and {A}_{1} = ( {j}_{1} , … , {j}_{\vert A \vert} ) , \\ or \\ {B}_{2} = ( {k}_{1} , … , {k}_{\vert B \vert} ) and {A}_{2} = ( {l}_{1} , … , {l}_{\vert A \vert} ) ,$$

and train two different models, one model for pair (B₁, A₁) and the one model for pair (B₂, A₂). Once the data collector trains one or more models to perform the inference phase for one or more pairs of Set A and Set B, the data collector may confirm its capability on the supported pairs of Set A and Set B for inference via a CSI report configuration.

To facilitate the training process of models implemented at the data collector, the data provider may apply the following restrictions to the measured set collected in the data collection process:

(1) All the CSI-RSs in the set may be transmitted with narrow beams. This is because if (e.g., when) some CSI-RSs are transmitted with wide beams, the data collector may not be able to categorize/group the RSs in the set based on the properties of wide beams or narrow beam.

(2) The full beam set may include both CSI-RSs and SSBs.

The data collector may categorize/group the RSs into Set A and Set B. The full beam set may be configured with one associated identifier, although the wide and narrow beams may be transmitted with wide codebooks and narrow codebooks.

(3) The data provider may configure a set of pairs {(A_{ref}, B_{ref})} for the data collection process. The data provider may send an indication, including the configured set of pairs, to the data collector, the data collector may be expecting the data provider configuring a pair (A,B) from the set of pairs in the inference phase.

Once the AI/ML model has trained for different pairs of Set A and Set B, the data collector implementing the AI/ML model may know which pairs the data collector supports. The data collector may then report the pairs of Set A and Set B it supports to the data provider via a capability report (e.g., the second capability report 415) for the inference phase. The contents of the capability report may be determined based on the following signaling designs:

Design 1 (specified pairs of sets): Multiple pairs of Set A and Set B may be indicated in the 3GPP specification. The data collector may indicate the supported pairs of Set A and Set B, e.g., via a bitmap indicating the associated identifiers of the specified pairs of Set A and Set B.

In Design 1, the data provider may only configure these sets indicated in the supported pairs during the inference phase. For example, if (e.g., when) the multiple pairs of Set A and Set B are indicated in the 3GPP specification, the data collector may only train an AI/ML model for these sets indicated in the multiple pairs. For example, if (e.g., when) the capability report (e.g., a UE capability signaling) only includes two pairs of Set A and Set B (B₁,A₁) and (B₂,A₂), the data collector may train a maximum of two AI/ML models, and report a length-2 bitmap to indicate the supported pairs, e.g., (1, 0) may indicate that the data collector supports the pair of Set A and Set B (B₁,A₁), but not the pair of Set A and Set B (B₂,A₂).

Design 2 (sizes of specified pairs): The sizes of multiple pairs may be specified in the 3GPP specification. The data collector may indicate which pairs it supports. If (e.g., when) the data collector indicates its support for a size of a pair (S_{B},S_{A}), the data provider may configure any pair (B,A) with the supported size |B|=S_{B} and |A|=S_{A} during the inference phase. Therefore, the data collector may train multiple AI/ML models to accommodate/cover all these different possibilities of set configurations. The capability report (e.g., a UE capability report signaling; the second capability report 415) may be in the form of a bitmap similar to Design 1.

Design 3 (specified maximum size of the sets): Multiple maximum sizes of sets may be specified in the 3GPP specification for Set A and Set B. The data collector may indicate the maximum size it supports for Set A and/or Set B. If (e.g., when) the data collector indicates that it supports a maximum size of S_{A,max} and S_{B,max} for Set A and Set B, respectively, the data collector may support configurations of any pair of sets (B, A) in the inference phase if (e.g., when) the size of Set B is less than or equal to the maximum size |B|≤S_{B,max}, and the size of Set A is less than or equal to the maximum size |A|≤S_{A,max}.

In one or more embodiments, if (e.g., when) the data collector declares/announces its capability on the supported pairs of Set A and Set B, the data provider may not configure a pair of Set A and Set B that the data collector does not support in the inference phase explicitly or implicitly, thereby improving the computational performance overall by not configuring unnecessary pairs.

In one or more embodiments, Design 1 to Design 3 may also be applied to Set A or Set B only, e.g., not a pair. For example, if (e.g., when) only Set B or the size of Set B is specified, the data collector may report the supported Set B and the supported size of Set B similar to the above processes for pairs. If (e.g., when) the data collector may only report the support for a given Set B, it may indicate that the data collector may support the given Set B with any arbitrary Set A.

In the embodiments that the associated identifier is a global associated identifier, if the data collector is configured with an associated identifier i in Cell A and the associated identifier i for Cell B, the additional conditions for the network side (e.g., additional conditions related to a gNB) may be the same for both Cell A and Cell B. For example, a total number of identified associated identifiers across all cells is

$${N}_{associated ID}^{g l o b a l} ,$$

the data provider may utilize associated identifiers within the same cell, e.g., for different beam codebooks. These N associated identifiers may be indicated in the 3GPP specification. For each associated identifier, the data collector (e.g., a UE) may move into/travel to a cell or zone to collect the data set associated with the associated identifier. If (e.g., when) the 3GPP specification defines

$${N}_{associated ID}^{g l o b a l}$$

associated identifiers, e.g., ID₁, ID₂, . . . , and

$${ID}_{{N}_{associated ID}^{g l o b a l}}$$

in each data collection process, the data provider may transmit some RSs with one associated identifier and some other RSs with a different associated identifier. In this case, the data collector may train different models for different associated identifiers even for the same pair of Set A and Set B (B,A). In the inference phase, the data collector may configure different pairs of Set A and Set B for the same associated identifier in different CSI report configurations (e.g., the third configuration 420) that may be simultaneously active. The data provider may also configure different associated identifiers for the same pair of Set A and Set B, either via a switching command between CSI report configurations or simultaneously active CSI report configurations.

In the embodiments of reporting the UE capability on associated identifiers, once the data collector trains its models for different pairs of Set A and Set B and their associated identifiers, the data collector may report its capability to support a combination of associated identifiers and pairs of Set A and Set B in a similar UE capability signaling design framework. The 3GPP specification may define

$${N}_{associated ID}^{g l o b a l}$$

associated identifiers. In the embodiments utilizing any of the capability signaling designs (e.g., Design 1 to Design 3), for each associated identifier, the data collector may declare its capability for supporting pairs of Set A and Set B. The data collector may declare a bitmap of length

$${N}_{associated ID}^{g l o b a l}$$

for the supported associated identifiers. If (e.g., when) the data collector declares the support of Nₛᵤₚₚₒᵣₜ associated identifiers, the data collector may also indicate the supported pairs of Set A and Set B according to any of the aforementioned UE capability signaling Designs 1 to 3 via Nₛᵤₚₚₒᵣₜ separate bitmaps. In one or more embodiments, the data collector may not declare any capability on the associated identifiers, which may refer that the data collector may support any associated identifiers configured with a pair of Set A and Set B, if the data collector declares the support for that Set A and Set B.

In the embodiments that the associated identifier is a local associated identifier, with a local associated identifier, e.g., a per-cell associated identifier, an associated identifier of 0 in a first cell may not imply the same implementation of the data provider (e.g., a gNB) as the implementation in a second cell. The data collector may know whether it may support a certain associated identifier if (e.g., when) the data collector connects to the cell. Moreover, the joint distribution of the RSRPs for a given a pair of Set A and Set B (B, A) for a first associated identifier may be different from that of a different associated identifier. Therefore, the data collector may support a pair of Set A and Set B (B, A) with the first associated identifier but not with a second associated identifier. To address the implication of the local associated identifier on the capability report, in the data collection process, the data collector may collect data based on a local associated identifier in the same way as a global associated identifier, except for one difference: if (e.g., when) the data collector is connected to a cell with a NR Cell Global Identity (NGCI), the data collector may explore all possible configured associated identifiers and the corresponding RSs during the data collection process. In this case, the data collector may train models for different 4-tuple (e.g., NGCI, associated identifiers, B, and A).

The data collector may collect data in two different cells and train models to support the following configurations:
Config #1: (NGCI #1, associated ID #1, B₁, A₁),
Config #2: (NGCI #1, associated ID #2, B₂, A₂),
Config #3: (NGCI #2, associated IDs #1, B₃, A₃), and
Config #4: (NGCI #2, associated IDs #2, B₄, A₄).

In the embodiments that the capability report is sent in RRC connected mode, once the data collector is connected to the cell with NGCI #1, the data collector may know which combinations of associated identifiers and which pairs of Set A and Set B that the data collector supports for the cell. The capability signaling framework in Design 1 to Design 3 with the corresponding associated identifier may be reused for a local associated identifier with the following conditions:

(1) The capability signaling framework in Design 1 to Design 3 may be reused. For example, the capability signaling framework may not be cell specific.

(2) NGCI may not affect or not be included in the capability signaling design because what the data collector reports may indicate the connected NGCI implicitly.

(3) For the associated identifier, because different data providers in different cells may configure different values of associated identifiers, what UE reports may be based on the maximum number of associated identifiers which may be configured per cell. For example, if (e.g., when) the maximum number is N, a length-┌log 2 N┐bit map may suffice. In this case, even if the first data provider (e.g., gNB1) may configure 4 associated identifiers, e.g., Associated Identifier #1, Associated Identifier #2, Associated Identifier #3, and Associated Identifier #4 for the first cell with NGCI #1, and a different data provider (e.g., gNB2) in a second cell with NGCI #2 may configure another 4 associated identifiers, e.g., Associated Identifier #5, Associated Identifier #6, Associated Identifier #7, and Associated Identifier #8, the data collector (e.g., the UE) may only need to report its support of four identifiers, so 2 bits of bitmap may be sufficient. In other words, the data collector may always sort the associated identifiers in ascending order, and report its capability based on the logical indices starting from 0.

By utilizing the method 200 for collecting data for training the AI/ML beam management model and the method 400 for beam management utilizing a trained AI/ML beam management model, more efficient, accurate inputs for training the AI/ML beam management may be provided, thereby improving the efficiency and accuracy of outputs of the trained AI/ML bean management. For example, the data collector may provide a capability report to indicate the properties/characteristics of Set A and Set B that the data collector may support, such that the data provider may efficiently configure corresponding resources for the data collector. Furthermore, the resources for Set A and Set B may be associated with one or more corresponding associated identifier, which may reduce the number of the associated identifiers in the training phase and efficiently categorize the resources based on their characteristics (e.g., size of Set A and Set B) for training, thereby improving the computational performance (e.g., reducing unnecessary computation) and the efficiency and accuracy of predicted beams for transmissions.

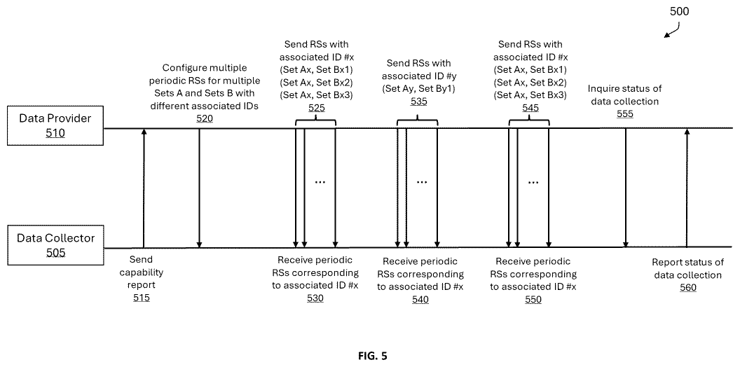

FIG. 5 is a diagram depicting another example method for collecting data for training an AI/ML beam management model, according to one or more embodiments of the present disclosure. Although FIG. 5 illustrates various operations in a method for collecting data for training an AI/ML beam management model, the present disclosure is not limited thereto, and according to various embodiments, the method may include additional operations, or fewer operations, or the order of operations may vary, unless otherwise stated or implied, without departing from the spirit and scope of embodiments according to the present disclosure.

Referring to FIG. 5, a method 500 for collecting data for training an AI/ML beam management model may be performed by a data collector 505 that may be connected with a data provider 510. The method 500 may be a data collection phase of the model development process. In one or more embodiments, the data collector 505 may be a UE or a gNB. For example, if (e.g., when) the data collector 505 is a UE, the data provider 510 may be a gNB and/or any network node at the network side for providing measurement data by sweeping through transmit beams. The gNB may be a dedicated gNB specific for the UE to collect AI/ML beam management-based data, a regular gNB in the network, and/or a virtual gNB which may be a test equipment. Likewise, if (e.g., when) the data collector 505 is a gNB, the data provider 510 may be a UE that may report measurements (e.g., the Layer 1 Reference Signal Received Power (L1-RSRP) measurements) of the beams that the gNB sweeps to the gNB.

In the method 500, the data collector 505 may start with sending a capability report 515 to the data provider 510 for the data provider 510 to configure suitable beams for transmissions. For example, the capability report 515 may indicate the capability of the data collector 505 for supporting beams associated with Set A beams and Set B beams. After the data collector 505 (e.g., a UE) is in the connection mode, the data collector 505 may send the capability report 515, which may include the capability for supporting certain combinations of Set A beams and Set B beams. The data provider 510 may configure multiple periodic RSs for multiple Sets A and Sets B with different associated identifiers 520 based on the capability report 515. In one or more embodiments, the capability may be transmitted in either the capability report 515 or an RRC signaling, e.g. UE assistance information, such that the data provider 510 (e.g., a gNB) may know how to provide required configurations for the data collector 505. For example, the configurations prepared by the data provider 510 may be associated with the combinations of Set A beams and Set B beams that the data collector 505 may support and are indicated in the capability report 515. The configuration sent from the data provider 510 may be utilized to initiate the data collector 505 to collect data based on measuring the configured resources.

In one or more embodiments, an additional signaling for which Set B sent from the data collector 505 to the data provider 510 may be required during the data collection phase and/or the inference phase.

Referring to FIG. 5, during the data collection process for multiple associated identifiers if (e.g., when) Set B is a subset of Set A, the data provider 510 may send RSs with different associated identifiers respectively. For example, the data provider 510 may send RSs with associated ID #x 525, e.g., (Set Ax, Set Bx1), (Set Ax, Set Bx2), (Set Ax, Set Bx3), and/or the like, and the data collector 505 may receive periodic RSs corresponding to associated ID #x 530 from the data provider 510. Furthermore, the data provider 510 may send RSs with associated ID #y 535, e.g., (Set Ay, Set By1) and/or the like, and the data collector 505 may receive periodic RSs corresponding to associated ID #y 540 from the data provider 510. In one or more embodiments, to collect enough data for training the AI/ML beam management model, the data provider 510 may further send RSs with associated ID #x 545, e.g., (Set Ax, Set Bx1), (Set Ax, Set Bx2), (Set Ax, Set Bx3), and/or the like, and the data collector 505 may receive periodic RSs corresponding to associated ID #x 550 from the data provider 510, until sufficient data has been collected by the data collector 505 for training the AI/ML beam management model and/or any other models.

The data provider 510 may inquire status of data collection 555, and in response to the inquiry, the data collector 505 may report the status of data collection 560. For example, if the data collector 505 may need more data for training the AI/ML beam management model, the data collector 505 may send another capability report or the data provider 510 may send more RSs associated with the associated identifier #x or the associated identifier #y.

FIG. 5 may indicate an example of signaling exchange between the data collector 505 and the data provider 510 for the data collection phase, which may be similar to the data collection phase shown in FIG. 2. In FIG. 5, Set B may be a subset of Set A, and therefore, the periodic RSs may be transmitted once for Set A. The signaling/report of RSs may be dynamic reflecting the status of data collection phase. A signaling/report may be linked to all configured associated identifiers, and each associated identifier may have its own signaling/report, which may allow the data provider 510 with more flexibility to reduce additional signaling overhead.

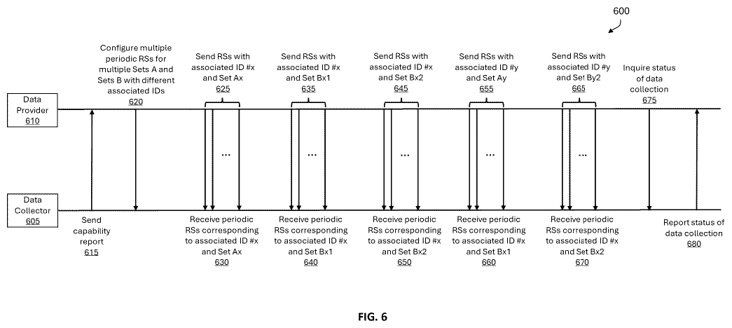

FIG. 6 is a diagram depicting yet another example method for collecting data for training an AI/ML beam management model, according to one or more embodiments of the present disclosure. Although FIG. 6 illustrates various operations in a method for collecting data for training an AI/ML beam management model, the present disclosure is not limited thereto, and according to various embodiments, the method may include additional operations, or fewer operations, or the order of operations may vary, unless otherwise stated or implied, without departing from the spirit and scope of embodiments according to the present disclosure.

Referring to FIG. 6, a method 600 for collecting data for training an AI/ML beam management model may be performed by a data collector 605 that may be connected with a data provider 610. The method 600 may be a data collection phase of the model development process. In one or more embodiments, the data collector 605 may be a UE or a gNB. For example, if (e.g., when) the data collector 605 is a UE, the data provider 610 may be a gNB and/or any network node at the network side for providing measurement data by sweeping through transmit beams. The gNB may be a dedicated gNB specific for the UE to collect AI/ML beam management-based data, a regular gNB in the network, and/or a virtual gNB which may be a test equipment. Likewise, if (e.g., when) the data collector 605 is a gNB, the data provider 610 may be a UE that may report measurements (e.g., the Layer 1 Reference Signal Received Power (L1-RSRP) measurements) of the beams that the gNB sweeps to the gNB.

In the method 600, the data collector 605 may start with sending a capability report 615 to the data provider 610 for the data provider 610 to configure suitable beams for transmissions. For example, the capability report 615 may indicate the capability of the data collector 605 for supporting beams associated with Set A beams and Set B beams. After the data collector 605 (e.g., a UE) is in the connection mode, the data collector 605 may send the capability report 615, which may include the capability for supporting certain combinations of Set A beams and Set B beams. For example, the data provider 610 may configure multiple periodic RSs for multiple Sets A and Sets B with different associated identifiers 620 based on the capability report 615. In one or more embodiments, the capability may be transmitted in either the capability report 615 or an RRC signaling, e.g. UE assistance information, such that the data provider 610 (e.g., a gNB) may know how to provide required configurations for the data collector 605. For example, the configurations prepared by the data provider 610 may be associated with the combinations of Set A beams and Set B beams that the data collector 605 may support and are indicated in the capability report 615. The configuration sent from the data provider 610 may be utilized to initiate the data collector 605 to collect data based on measuring the configured resources.

In the case that Set B is not a subset of Set A, the data provider 610 may configure separate RSs for Set A and Set B and transmit RSs for Set A and RSs for Set B separately. For example, the data provider 610 may send RSs with associated ID #x and Set Ax 625, and the data collector 605 may receive periodic RSs corresponding to associated ID #x and Set Ax 630 from the data provider 610. Furthermore, the data provider 610 may send RSs with associated ID #x and Set Bx1 635, and the data collector 605 may receive periodic RSs corresponding to associated ID #x and Set Bx1 640 from the data provider 610. The data provider 610 may further send RSs with associated ID #x and Set Bx2 645, and the data collector 605 may receive periodic RSs corresponding to associated ID #x and Set Bx2 650 from the data provider 610. Furthermore, the data provider 610 may send RSs with associated ID #y and Set Ay 655, and the data collector 605 may receive periodic RSs corresponding to associated ID #y and Set Ay 660 from the data provider 610. The data provider 610 may further send RSs with associated ID #y and Set By2 665, and the data collector 605 may receive periodic RSs corresponding to associated ID #y and Set By2 670 from the data provider 610.

The data provider 610 may inquire status of data collection 675, and in response to the inquiry, the data collector 605 may report the status of data collection 680. For example, if the data collector 605 may need more data for training the AI/ML beam management model, the data collector 605 may send another capability report or the data provider 610 may send more RSs associated with the associated identifier #x or the associated identifier #y.

In one or more embodiments, the configuration/report for data collection may be dynamic reporting, semi-persistent reporting, or periodic reporting.

Additionally, if (e.g., when) the data collector 605 collects data in a particular window, this window may be considered as measurement gap, in which the uplink transmission and the downlink reception may not be allowed. This window may be defined as the symbols/slots/subframes including the measured RSs. After the data collector 605 reports the completion of data collection for a particular associated identifier (e.g., Associated ID #x and/or Associated ID #y), the window for the RSs linked to this associated identifier may not be considered as a measurement gap. For example, the data collector 605 may transmit uplink transmissions and receive downlink transmissions in the instance where RSs of the particular associated identifier may no longer be monitored, either because the completion of data collection or the data collector 605 may not be interested in collecting data for this associated ID.

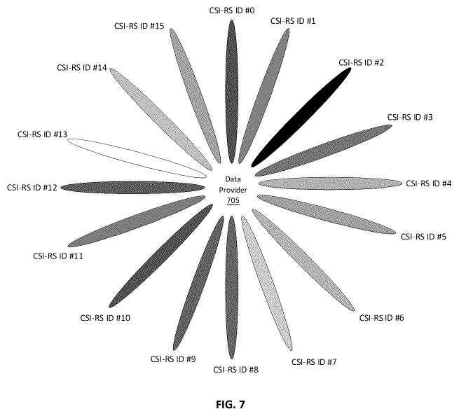

FIG. 7 is a diagram depicting an example full beam set associated with different associated identifiers, according to one or more embodiments of the present disclosure.

Referring to FIG. 7, a data collector 705 may include RSs associated with Associated IDs #0 to #15. A data collector (e.g., a UE) may choose the sets of beams for training models, such that the sets of beams may be configured by the data provider 705 in the inference phase. For example, a pair of sets may be configured by the data provider 705, if the set of beams corresponding to the RSs in the two sets are spatially close to each other. For example, if (e.g., when) Set B={0,1,15}, then Set A may include beams which are spatially close to Set B, e.g. {2,3,4,12,13,14}, where the RSs, such as Associated IDs #7, #8, and #9 from Set A that are far from the data collector may be excluded. It may be beneficial to exclude some RSs in Set A to keep a reduced size of Set A and to improve the accuracy of the AI/ML beam management model. Furthermore, removing unnecessary RSs from the sets of beams may reduce overhead. For these above reasons, even within the same cell and same associated ID, in the inference phase, the data provider 705 may still be able to configure different sets, e.g., different CSI report configurations with different sets, according to the mobility/location of the data collector.

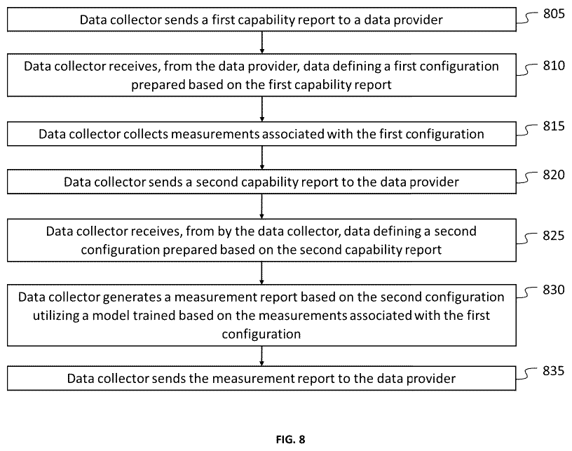

FIG. 8 is a flowchart depicting aspects of a method for beam management, according to some embodiments of the present disclosure.

Although FIG. 8 illustrates various operations in a method for beam management, one or more embodiments according to the present disclosure are not limited thereto, and according to one or more embodiments, the method may include additional operations or fewer operations, or the order of operations may vary, unless otherwise stated or implied, without departing from the spirit and scope of embodiments according to the present disclosure.

Referring to FIG. 8, at operation 805, a data collector (e.g., the base station 102 or the wireless device 104 shown in FIG. 1; the data collectors 205, 405, 505, and 605 shown in FIGS. 2 and 4-6) may send a first capability report to a data provider (e.g., the base station 102 or the wireless device 104 shown in FIG. 1; the data providers 210, 410, 510, and 610 shown in FIGS. 2 and 4-6). For example, the data collector may be a UE that may send a capability report, which may include the UE implementation, the capability for supporting data collection, the capability for supporting properties of resources for Set A and/or Set B, the restrictions of the UE, to the data provider (e.g., a gNB). In one or more embodiments, the data collector may be a gNB that may send a capability report, which may include the capability for supporting data collection, the capability for supporting properties of resources for Set A and/or Set B, the restrictions of the gNB, to the data provider (e.g., a UE). In one or more embodiments, the first capability report may include UE assistant information, the UE assistant information including minimum measurement samples and/or maximum transmission data per session. For example, due to the restrictions of the UE implementation and/or the limitation of the UE, the UE (e.g., the data collector) may only transmit minimum required information to the gNB (e.g., the data provider) for configuration.

At operation 810, the data collector may receive, from the data provider, data defining a first configuration prepared based on the first capability report. The first configuration may include a first set of resources and a second set of resources, and the first set of resources and the second set of resources may be associated with at least one associated identifier. For example, the first set of resources may be associated with a first associated identifier, and the second set of resources may be associated with a second associated identifier. In one or more embodiments, the first configuration may include a configuration parameter indicating the data collector to collect the measurements. Furthermore, in one or more embodiments, the first configuration may include a report quantity indicating the data collector not to send information associated with measurement data on the first set of resources and the second set of resources to the data provider (e.g., only collecting data). For example, the data receiver may indicate the data collector not to send a Channel State Information” (CSI) report nor any information that may convey measurement data based on measuring the configured resources (e.g., the first set of resources and the second set of resources).

In one or more embodiments, the first set of resources may be associated with a first associated identifier, and the second set of resources may be associated with a second associated identifier.

In one or more embodiments, the second set of resources may be a subset of the first set of resources, and the first configuration may include a first associated identifier, reference signals for the first set of resources, and an index of reference signals for the second set of resources for determining the measurement report.

In one or more embodiments, the second set of resources may include a different set of resources from the first set of resources, and the first configuration comprises reference signals for the second set of resources that may be different from the first set of resources.

In one or more embodiments, the first configuration may include a report quantity indicating the data collector not to send information associated with measurement data on the first set of resources and the second set of resources to the data provider.

In one or more embodiments, the first configuration may include Central Processing Unit (CPU) occupation time, Channel State Information (CSI) processing time, and/or a number of occupied CPU for the data collector. For example, the gNB (e.g., the data provider) may configure the UE (e.g., the data collector) with some characteristics, such as the CPU occupation time, the CSI processing time, and/or the number of occupied CPU, such that the overhead at the UE may be reduced.

At operation 815, the data collector may collect measurements associated with the first configuration. For example, the UE (e.g., the data collector) may receive resources for Set A that may be associated with the first associated identifier and resources for Set B that may be associated with the same identifier (the first associated identifier) or a different identifier (the second associated identifier) for training a AI/ML model for identifying suitable beams.

At operation 820, the data collector may send, to the data provider, a second capability report.

At operation 825, the data collector may receive, from by the data collector, data defining a second configuration prepared based on the second capability report.

At operation 830, the data collector may generate a measurement report based on the second configuration utilized a model trained based on the measurements associated with the first configuration. For example, the UE (e.g., the data collector) may utilized the trained model to identify suitable beams for transmissions.

At operation 835, the data collector may send, to the data provider, the measurement report. For example, the measurement report may include suitable beams for Tx and Rx between the data collector and the data provider. The data collector may transmit transmission with the suitable beams to the data provider.

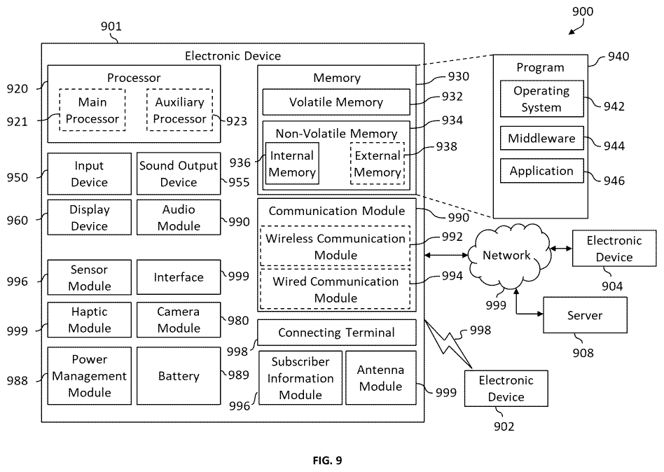

FIG. 9 is a block diagram of an electronic device in a network environment, according to some embodiments of the present disclosure.

Referring to FIG. 9, an electronic device 901 (e.g., the base station 102 or the wireless device 104 shown in FIG. 1; the data collectors 205, 405, 505, and 605 shown in FIGS. 2, 4, 5, and 6, such as a UE, and/or a network node at the network side) in a network environment 900 (e.g., the wireless communication system 100 shown in FIG. 1) may communicate with an external electronic device 902 (e.g., another base station 102 or another wireless device 104 shown in FIG. 1; the data providers 210, 410, 510, and 610 shown in FIGS. 2, 4, 5, and 6, such as a gNB, and/or a UE) via a first network 998 (e.g., a short-range wireless communication network), or with an external electronic device 904 or a server 908 via a second network 999 (e.g., a long-range wireless communication network). The electronic device 901 may communicate with the external electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, and/or an antenna module 997. In one embodiment, at least one of the components (e.g., the display device 960 or the camera module 980) may not be provided from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled to the processor 920, and may perform various data processing or computations. For example, the processor 920 may be a processing circuit of a UE and execute instructions to perform methods disclosed in FIGS. 2, 4-6, and 8, e.g., the processor 920 may execute instruction to determine a measurement report (e.g., suitable predicted beams based on characteristics of beams) utilizing an AI/ML model trained based on the collected data (e.g., resources associated with different associated identifiers).

As at least a part of the data processing or computations, the processor 920 may load a command or data received from another component (e.g., the sensor module 976 or the communication module 990) in volatile memory 932, may process the command or the data stored in the volatile memory 932, and may store resulting data in non-volatile memory 934. The processor 920 may include a main processor 921 (e.g., a central processing unit or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or to execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990), as opposed to the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 960 may visually provide information to the outside (e.g., to a user) of the electronic device 901. The display device 960 may include, for example, a display, a hologram device, and/or a projector, and may include control circuitry to control a corresponding one of the display, the hologram device, and/or the projector. The display device 960 may include touch circuitry adapted to detect a touch, and/or may include sensor circuitry (e.g., a pressure sensor) adapted to measure the intensity of force incurred by the touch.

The audio module 970 may convert a sound into an electrical signal and vice versa. The audio module 970 may obtain the sound via the input device 950 and/or may output the sound via the sound output device 955 or a headphone of an external electronic device 902 directly (e.g., wired) or wirelessly coupled to the electronic device 901.

The sensor module 976 may detect an operational state (e.g., power or temperature) of the electronic device 901, and/or an environmental state (e.g., a state of a user) external to the electronic device 901. The sensor module 976 may then generate an electrical signal and/or a data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 977 may support one or more specified protocols to be used for the electronic device 901 to be coupled to the external electronic device 902 directly (e.g., wired) or wirelessly. The interface 977 may include, for example, a high-definition multimedia interface (HDMI), a universal serial bus (USB) interface, a secure digital (SD) card interface, and/or an audio interface.

A connecting terminal 978 may include a connector via which the electronic device 901 may be physically connected to the external electronic device 902. The connecting terminal 978 may include, for example, an HDMI connector, a USB connector, an SD card connector, and/or an audio connector (e.g., a headphone connector).

The haptic module 979 may convert an electrical signal into a mechanical stimulus (e.g., a vibration or a movement) and/or an electrical stimulus, which may be recognized by a user via tactile sensation or kinesthetic sensation. The haptic module 979 may include, for example, a motor, a piezoelectric element, and/or an electrical stimulator.

The camera module 980 may capture a still image and/or moving images. The camera module 980 may include one or more lenses, image sensors, image signal processors, and/or flashes. The power management module 988 may manage power that is supplied to the electronic device 901. The power management module 988 may be implemented as at least a part of, for example, a power management integrated circuit (PMIC).

The battery 989 may supply power to at least one component of the electronic device 901. The battery 989 may include, for example, a primary cell that is not rechargeable, a secondary cell that is rechargeable, and/or a fuel cell.

The communication module 990 may support establishing a direct (e.g., wired) communication channel and/or a wireless communication channel between the electronic device 901 and the external electronic device (e.g., the external electronic device 902, the external electronic device 904, and/or the server 908), and may support performing communication via the established communication channel. The communication module 990 may include one or more communication processors that are operable independently from the processor 920 (e.g., the AP), and may support a direct (e.g., wired) communication and/or a wireless communication. The communication module 990 may include a wireless communication module 992 (e.g., a cellular communication module, a short-range wireless communication module, and/or a global navigation satellite system (GNSS) communication module) and/or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, and/or a standard of the Infrared Data Association (IrDA)), or via the second network 999 (e.g., a long-range communication network, such as a cellular network, the Internet, and/or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 and/or the second network 999, utilizing subscriber information (e.g., international mobile subscriber identity (IMSI)) stored in the subscriber identification module 996.

The antenna module 997 may transmit or receive a signal and/or power to or from the outside (e.g., the external electronic device) of the electronic device 901. The antenna module 997 may include one or more antennas. The communication module 990 (e.g., the wireless communication module 992) may select at least one of the one or more antennas appropriate for a communication scheme used in the communication network, such as the first network 998 and/or the second network 999. The signal and/or the power may then be transmitted and/or received between the communication module 990 and the external electronic device via the selected at least one antenna.

Commands or data may be transmitted and/or received between the electronic device 901 and the external electronic device 904 via the server 908 coupled to the second network 999. Each of the external electronic devices 902 and 904 may be a device of a same type as, or a different type, from the electronic device 901. All or some of operations to be executed at the electronic device 901 may be executed at one or more of the external electronic devices 902 or 904, or server 908. For example, if the electronic device 901 should perform a function or a service automatically, or in response to a request from a user or another device, the electronic device 901, instead of, or in addition to, executing the function or the service, may request the one or more external electronic devices to perform at least a part of the function or the service. The one or more external electronic devices receiving the request may perform the at least a part of the function or the service requested, or an additional function or an additional service related to the request and transfer an outcome of the performing to the electronic device 901. The electronic device 901 may provide the outcome, with or without further processing of the outcome, as at least a part of a reply to the request. To that end, cloud computing, distributed computing, and/or client-server computing technology may be utilized, for example.

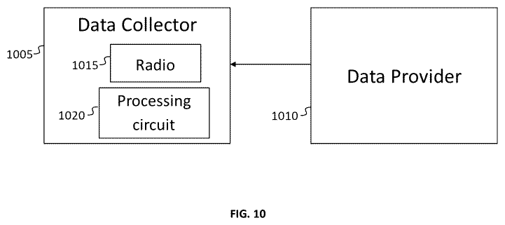

FIG. 10 shows a system including a data collector 1005 (e.g., the wireless device 104, the data collectors 205, 405, 505, and 605 shown in FIGS. 2, 4, 5, and 6, such as a UE, and/or a network node at the network side) and a data collector 1010 (e.g., the base station 102, the data providers 210, 410, 510, and 610 shown in FIGS. 2, 4, 5, and 6, and/or a gNB), in communication with each other. The data collector 1005 may include a radio 1015 and a processing circuit (or a means for processing) 1020, which may perform one or more suitable methods disclosed herein, e.g., the methods illustrated in FIGS. 2, 4-6, and 8. For example, the processing circuit 1020 of the data collector 1005 may receive, via the radio 1015, transmissions (e.g., a configuration, and/or reference signals) from the data collector 1010, determine a measurement report based on a configuration prepared based on the capability of the data collector 1005, and provide the measurement report to the data provider 1010 for optimizing beam management/beam selection.

As described above, the characteristics of embodiments according to the present disclosure provide improvements to the training of an AI/ML beam management model and the beam management by utilizing the associated identifiers to categorize resources for the training purpose, thereby improving the efficiency of the trained AI/ML beam management model and the accuracy of the outputs of the trained AI/ML beam management model, including a beam prediction for transmission.

Furthermore, the disclosed data collection process in the training phase may reduce the number of associated identifiers and the number of RSs included in the beam selection/prediction, thereby reducing overhead in the training process and the inference process.

Embodiments of the subject matter and the operations described in this specification may be implemented in digital electronic circuitry, or in computer software, firmware, and/or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, and/or to control the operation of data-processing apparatus. Alternatively or additionally, the program instructions can be encoded on an artificially-generated propagated signal, e.g., a machine-generated electrical, optical, and/or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, and/or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices and/or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in any sequential order, or that all illustrated operations be performed, to achieve desirable results. In certain circumstances, multitasking and parallel processing may be advantageous or suitable. Moreover, the separation of various system components in the embodiments described above should not be understood as requiring such separation in all embodiments, and it should be understood that the described program components and systems can generally be integrated together in a single software product or packaged into multiple software products.

Thus, aspects of some embodiments of the present disclosure have been described herein. Other embodiments are within the scope of the following claims and their equivalents. In some cases, the actions set forth in the claims may be performed in a different order and still achieve desirable or desired results. Additionally, the processes depicted in the accompanying figures do not necessarily require the particular order shown, or sequential order, to achieve desirable or desired results. In certain implementations, multitasking and parallel processing may be advantageous, suitable or desirable.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, with functional equivalents thereof to be included therein.

1. A method comprising:
sending, by a data collector to a data provider, a first capability report;
receiving, from the data provider by the data collector, data defining a first configuration prepared based on the first capability report, wherein the first configuration comprises a first set of resources and a second set of resources, the first set of resources and the second set of resources associated with at least one associated identifier;
collecting, from the data provider by the data collector, measurements associated with the first configuration;
sending, by the data collector to the data provider, a second capability report;
receiving, from the data provider by the data collector, data defining a second configuration prepared based on the second capability report;
generating, by the data collector, a measurement report based on the second configuration utilizing a model trained based on the measurements associated with the first configuration; and
sending, by the data collector to the data provider, the measurement report.

2. The method of claim 1, wherein the first configuration comprises a configuration parameter indicating the data collector to collect the measurements.

3. The method of claim 1, wherein the first set of resources is associated with a first associated identifier, and the second set of resources is associated with a second associated identifier.

4. The method of claim 1, wherein the second set of resources is a subset of the first set of resources, and the first configuration comprises at least one of a first associated identifier, reference signals for the first set of resources, or an index of reference signals for the second set of resources for determining the measurement report.

5. The method of claim 3, wherein the second set of resources comprises a different set of resources from the first set of resources, and wherein the first configuration comprises reference signals for the second set of resources that are different from the first set of resources.

6. The method of claim 1, wherein the first configuration comprises a report quantity indicating the data collector not to send information associated with measurement data on the first set of resources and the second set of resources to the data provider.

7. The method of claim 1, wherein the first configuration comprises a report quantity indicating at least one of Central Processing Unit (CPU) occupation time, Channel State Information (CSI) processing time, or a number of occupied CPU for the data collector.

8. The method of claim 1, wherein the first capability report comprises UE assistant information, wherein the UE assistant information comprises at least one of minimum measurement samples or maximum transmission data per session.

9. A data collector comprising a processing circuit, the processing circuit being configured to perform:
sending, to a data provider, a first capability report;
receiving, from the data provider, data defining a first configuration prepared based on the first capability report, wherein the first configuration comprises a first set of resources and a second set of resources, the first set of resources and the second set of resources associated with at least one associated identifier;
collecting, from the data provider, measurements associated with the first configuration;
sending, to the data provider, a second capability report;
receiving, from the data provider, data defining a second configuration prepared based on the second capability report;
generating a measurement report based on the second configuration utilizing a model trained based on the measurements associated with the first configuration; and
sending, to the data provider, the measurement report.

10. The data collector of claim 9, wherein the first configuration comprises a configuration parameter indicating the data collector to collect the measurements.

11. The data collector of claim 9, wherein the first set of resources is associated with a first associated identifier, and the second set of resources is associated with a second associated identifier.

12. The data collector of claim 9, wherein the second set of resources is a subset of the first set of resources, and the first configuration comprises at least one of a first associated identifier, reference signals for the first set of resources, or an index of reference signals for the second set of resources for determining the measurement report.

13. The data collector of claim 11, wherein the second set of resources comprises a different set of resources from the first set of resources, and the first configuration comprises reference signals for the second set of resources that are different from the first set of resources.

14. The data collector of claim 9, wherein the first configuration comprises a report quantity indicating the data collector not to send information associated with measurement data on the first set of resources and the second set of resources to the data provider.

15. The data collector of claim 9, wherein the first configuration comprises a report quantity indicating at least one of Central Processing Unit (CPU) occupation time, Channel State Information (CSI) processing time, or a number of occupied CPU for the data collector.

16. The data collector of claim 9, wherein the first capability report comprises UE assistant information, the UE assistant information comprising at least one of minimum measurement samples or maximum transmission data per session.

17. A non-transitory computer-readable medium comprising:
instructions that, when executed by a processor, cause the processor to perform:
sending, by a data collector to a data provider, a first capability report;
receiving, from the data provider by the data collector, data defining a first configuration prepared based on the first capability report, wherein the first configuration comprises a first set of resources and a second set of resources, the first set of resources and the second set of resources associated with at least one associated identifier;
collecting, from the data provider by the data collector, measurements associated with the first configuration;
sending, by the data collector to the data provider, a second capability report;
receiving, from the data provider by the data collector, data defining a second configuration prepared based on the second capability report;
generating a measurement report based on the second configuration utilizing a model trained based on the measurements associated with the first configuration; and
sending, to the data provider, the measurement report.

18. The non-transitory computer-readable medium of claim 17, wherein the first configuration comprises a configuration parameter indicating the data collector to collect the measurements.

19. The non-transitory computer-readable medium of claim 17, wherein the first set of resources is associated with a first associated identifier, and the second set of resources is associated with a second associated identifier.

20. The non-transitory computer-readable medium of claim 17, wherein the second set of resources is a subset of the first set of resources, and wherein the first configuration comprises at least one of a first associated identifier, reference signals for the first set of resources, or an index of reference signals for the second set of resources for determining the measurement report.

21. The method of claim 1, further comprising:
sending, by the data collector to the data provider, an indication indicating a completion of the collecting of the measurements associated with the first configuration.
